(19) United States
(12) Patent Application Publication
(10) Pub. No.: US 2026/0109283 A1
(43) Pub. Date: Apr. 23, 2026

(54) HIDDEN-TYPE CUP HOLDER DEVICE AND CONSOLE SYSTEM INCLUDING THE SAME

(71) Applicant: SEOYON E-HWA CO., LTD., Anyang (KR)

(72) Inventors: Man Soon PARK, Anyang (KR); Yong Su Lee, Anyang (KR)

(21) Appl. No.: 19/356,251

(22) Filed: Oct. 13, 2025

(30) Foreign Application Priority Data
Oct. 17, 2024 (KR) 10-2024-0142110

(51) Int. Cl. B60N 3/10; B60Q 3/225; B60Q 3/82

(52) U.S. Cl. CPC B60N 3/102; B60Q 3/229; B60Q 3/82

(57) ABSTRACT

Disclosed are a hidden-type cup holder device and a console system including the hidden-type cup holder device, wherein the hidden-type cup holder device is configured to enable a vehicle occupant to fully use a storage space formed in a console during normal operation and to deploy, in response to a button-pressing operation by the vehicle occupant, a hidden cup holder from a bottom portion of the storage space formed in the console when necessary.

The present application claims priority to and the benefit of Korean Patent Application No. 10-2024-0142110, filed on October 17, 2024, in the Korean Intellectual Property Office, the entire disclosure of which is incorporated herein by reference.

### BACKGROUND

### 1. Field

The present disclosure relates to a hidden-type cup holder device and a console system including the same, and more particularly, to a hidden-type cup holder device configured to enable a vehicle occupant to fully use a storage space formed in a console during normal operation and to deploy, in response to a button-pressing operation by the vehicle occupant, a hidden cup holder from a bottom portion of the storage space formed in the console when necessary, and a console system including the hidden-type cup holder device.

### 2. Description of the Related Art

A console device is installed between a driver-side seat and a passenger-side seat in the vehicle interior. The console device provides a storage space for items and serves as an armrest, thereby improving convenience for a vehicle occupant.

Particularly, a cup holder is provided in the vehicle interior to temporarily store beverages and other items of a vehicle occupant.

A cup holder device is generally visible to a vehicle occupant. In this case, since the cup holder device occupies space in the vehicle interior, aesthetics of the vehicle interior may deteriorate due to the exposed cup holder device.

To address the above-described problems, there have been proposed various techniques enabling a cup holder device to be deployed (unfolded) when needed from a general state in which the cup holder device is folded.

However, in the case of such a deployable cup holder device, there is a problem in that the cup holder device in the folded state is exposed and is visually recognized by a vehicle occupant, leading to deterioration in aesthetics of the vehicle interior. Furthermore, even if the cup holder device is positioned in the folded state in a storage space formed in a console, the cup holder device occupies a part of the storage space. Accordingly, the storage space may not be fully utilized. Further, an item may become caught in the cup holder device exposed in the storage space.

Additionally, it is difficult for a vehicle occupant to check whether the cup holder device is fully deployed at night when the vehicle interior is dark. Additionally, when a beverage in the cup holder is spilled due to incomplete deployment of the cup holder, the vehicle interior is contaminated by the beverage, and the driver is momentarily distracted, resulting in a significant increase in vehicle accidents.

### [Related Art Document]

(Patent Document 1) Korean Patent Laid-Open Publication No. 10-2023-0161233

(Patent Document 2) Korean Patent No. 10-2370494

(Patent Document 3) Korean Patent No. 10-2102270

### SUMMARY

Therefore, the present disclosure has been made in view of the above problems, and it is an object of the present disclosure to provide a cup holder device configured such that, since a cup holder is completely hidden when not in use, a vehicle occupant fully uses an item storage space formed in a console without visually recognizing a cup holder device, and when necessary, the cup holder is deployed in response to operation by the vehicle occupant.

It is another object of the present disclosure to provide a cup holder device capable of solving a problem related to deterioration in aesthetics of the vehicle interior due to a conventional cup holder device occupying a vehicle interior space.

It is a still further object of the present disclosure to provide a cup holder device capable of solving a problem in which, in the case of a deployable cup holder device, even though the cup holder device is positioned in the folded state in a storage space formed in a console, a part of the storage space is occupied by the cup holder device such that the storage space is not fully usable, and a problem in which an item is caught in the cup holder device exposed in the storage space.

It is a yet further object of the present disclosure to provide a cup holder device configured to enable a vehicle occupant to check whether a cup holder is fully deployed at night when the vehicle interior is dark, thereby preventing spillage of a beverage from the cup, and to prevent a vehicle accident caused by distracted driving of a driver when a beverage spills out of the cup due to inappropriate deployment of the cup holder.

The objects of the present disclosure are not limited to the above-mentioned objects, and other technical objects not mentioned herein will be clearly understood by those skilled in the art to which the present disclosure pertains from the detailed description of the embodiments.

In accordance with an aspect of the present disclosure, the above and other aspects can be accomplished by the provision of a hidden-type cup holder device including a housing disposed in a console and comprising an item storage space defined by a first space area and a second space area connected to each other, and a base unit mounting part provided at a lower portion of the first space area, a support member fixedly mounted on the housing, a base unit positioned on the base unit mounting part, wherein the base unit has an upper surface formed to be flush with a bottom surface of the second space area to form a bottom surface of the first space area, one end of the base unit is supported by the support member, and an opposite end of the base unit is rotated by a first predetermined angle to be erected in the item storage space, and a cup holder unit mounted on the base unit, the cup holder unit being rotatably deployed at a second predetermined angle to provide a cup support space for storing a cup therein.

The hidden-type cup holder device may further include a skin member including a first skin area fixedly in contact with the upper surface of the base unit, a second skin area fixedly in contact with the bottom surface of the second space area, and a connection area formed of a flexible material and connecting the first skin area to the second skin area, and entirety of an upper surface of the skin member may be formed as a single surface and may be continuously flat.

The housing may have a step defined by a height difference between the bottom surface of the second space area and the base unit mounting part and may further include asupport member mounting hole formed in the step, and the support member may include a support plate fixedly mounted on an underside of the bottom surface of the second space area, and a base unit coupling part extending from the support plate, and coupled to the base unit through the support member mounting hole to support rotation of the base unit.

The base unit may include an upper plate having an upper surface forming the bottom surface of the first space area, the upper plate including a base rotation means mounting part provided at an inner surface of a rear end portion of the upper plate, a lower plate coupled to a lower portion of the upper plate and configured for the cup holder unit to be mounted thereon, the lower plate including a support member coupling hole opening at a rear side surface of the lower plate, the support member coupling hole being receiving a part of the support member, and a base rotation means having one portion fixedly mounted on the base rotation means mounting part of the upper plate and the other portion rotatably mounted on the support member such that the base rotation means is rotated by first elastic force.

The base unit may further include a base locking hole provided in a side surface thereof, and the hidden-type cup holder device may further include a main switch unit mounted on the housing, the main switching unit including a base locking protrusion inserted into and coupled to the base locking hole in the base unit to restrict rotation of the base unit by the first elastic force of the base rotation means, the base locking protrusion being configured to be withdrawn from the base locking hole in the base unit in response to operation by a vehicle occupant.

The cup holder unit may include a cup holder fixing member fixedly mounted on the lower plate of the base unit, a cup holder body configured to provide the cup support space for storing the cup therein, the cup holder body including a cup holder rotation means mounting part provided on an inner surface of a rear portion of the cup holder body, a cup holder lower case coupled to a lower portion of the cup holder body, the cup holder lower case including a cup holder fixing member coupling hole opening at a rear side surface of the cup holder lower case, the cup holder fixing member coupling hole receiving a part of the cup holder fixing member, and a cup holder rotation means having one portion fixedly mounted on the cup holder rotation means mounting part of the cup holder body and the other portion rotatably mounted on the cup holder fixing member such that the cup holder body is rotatably deployed from the base unit by second elastic force.

The cup holder unit may further include a cup support means, wherein one end of the cup support means is rotatably mounted on the cup holder lower case, and an opposite end of the cup support means contacts the cup stored in the cup support space, thereby elastically pushing the cup stored in the cup support space to maintain a position of the cup.

The cup holder lower case of the cup holder unit may further include a cup holder locking hole provided in a lower surface of the cup holder lower case, and the hidden-type cup holder device may further include a cup holder switch unit mounted on the base unit, the cup holder switch unit including a cup holder locking protrusion locked in and coupled to the cup holder locking hole in the cup holder unit to restrict rotational deployment of the cup holder body by the second elastic force of the cup holder rotation means, the cup holder locking protrusion being configured to be unlocked from the cup holder locking hole in the cup holder unit in response to operation by a vehicle occupant.

The hidden-type cup holder device may further include a stopper means including a first stopper member, and a second stopper member provided on the base unit so as to allow, when the base unit is rotated by the first predetermined angle to be erected in the item storage space, an end surface of the second stopper member to contact an end surface of the first stopper member, and the first stopper member and the second stopper member may contact each other to restrict rotation of the base unit such that the base unit is not rotated beyond the first predetermined angle of the base unit.

The hidden-type cup holder device may further include a cup holder deployment light-emitting means including a light-emitting part provided on the cup holder unit and configured to emit light when power is applied thereto, a power supply part configured to supply the power, and an upper contact terminal including a first upper contact terminal provided on an outer surface of the cup holder body of the cup holder unit, the first upper contact terminal being electrically connected to the light-emitting part, and a second upper contact terminal provided on an inner surface of the lower plate of the base unit, the second upper contact terminal being electrically connected to the power supply part, and when the cup holder unit is rotatably deployed from the base unit within a predetermined range, the first upper contact terminal and the second upper contact terminal may contact each other to cause the light-emitting part to emit light.

The cup holder unit may further include a cup support means, wherein one end of the cup support means is rotatably mounted on the cup holder lower case, and an opposite end of the cup support means contacts the cup stored in the cup support space, thereby elastically pushing the cup stored in the cup support space to maintain a position of the cup, the cup holder deployment light-emitting means may further include a cup detection part provided on the cup support means, the cup detection part being configured to detect contact between the cup support means and the cup stored in the cup support space, and the light-emitting part may emit the light having different colors depending on a detection result by the cup detection part.

The hidden-type cup holder device may further include a cup holder deployment light-emitting means including a light-emitting part provided on the cup holder unit and configured to emit light when power is applied thereto, a power supply part configured to supply the power, and a lower contact terminal including a lower first contact terminal provided on the end surface of the first stopper member, the lower first contact terminal being electrically connected to the power supply part, and a lower second contact terminal provided on the end surface of the second stopper member, the lower second contact terminal being electrically connected to the light-emitting part, and when the base unit is supported by the support member and is rotated to be erected within a predetermined range, the lower first contact terminal and the lower second contact terminal may contact each other to cause the light-emitting part to emit the light.

A console system may be disposed in a vehicle interior and may include at least one hidden-type cup holder device described above.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIGS. 1 and 2 are views each showing an example of a console system according to the present disclosure;

FIG. 3 is a view showing an embodiment of a cup holder device according to the present disclosure;

FIG. 4 is an exploded view of main components of the embodiment of the cup holder device according to the present disclosure;

FIGS. 5 and 6 are exploded views of an embodiment of a base unit and a main switch unit of the cup holder device according to the present disclosure;

FIGS. 7A-7B are exemplary operational views of the main switch unit of the cup holder device according to the present disclosure;

FIGS. 8A-8B are exemplary operational view of the base unit of the cup holder device according to the present disclosure;

FIGS. 9 and 10 are exploded views of an embodiment of the base unit and a cup holder unit of the cup holder device according to the present disclosure;

FIGS. 11A-11B are exemplary cross-sectional views showing operation of the cup holder unit of the cup holder device according to the present disclosure;

FIGS. 12A-12B are exemplary operational views of the cup holder unit of the cup holder device according to the present disclosure;

FIGS. 13A-13B are views showing an exemplary method of storing a cup in the cup holder device according to the present disclosure;

FIGS. 14A-14B are views showing an example of the cup holder device including a stopper means according to the present disclosure;

FIGS. 15A-15B are cross-sectional views showing operation of an exemplary stopper means of the cup holder device according to the present disclosure;

FIG. 16 is a view showing an embodiment of a cup holder deployment light-emitting means of the cup holder device according to the present disclosure;

FIGS. 17A-17B are cross-sectional views showing operation of an exemplary lower contact terminal of the cup holder deployment light-emitting means of the cup holder device according to the present disclosure;

FIG. 18 is a view showing an exemplary equivalent circuit of the cup holder deployment light-emitting means of the cup holder device according to the present disclosure; and

FIGS. 19A-19C and 20A-20C are operational views of an embodiment of the cup holder deployment light-emitting means of the cup holder device according to the present disclosure.

### DETAILED DESCRIPTION OF EXEMPLARY EMBODIMENTS

Hereinafter, preferred embodiments of the present disclosure will be described in detail with reference to the accompanying drawings. The present disclosure may, however, be embodied in many different forms, and should not be construed as being limited to the embodiments set forth herein.

The following embodiments are provided to describe the present disclosure more clearly, including the operational advantages thereof, and the purpose achieved by implementation of the present disclosure, with reference to the accompanying drawings.

First, in the present disclosure, the terms used herein are only used to describe specific embodiments and are not intended to limit the present disclosure. In this specification, an expression in a singular form also encompasses the plural sense, unless clearly specified otherwise in context. Additionally, it should be understood that expressions such as "comprise" and "have" in this specification are intended to designate the presence of indicated features, numbers, steps, operations, components, parts, or combinations thereof, but do not exclude the presence or addition of one or more features, numbers, steps, operations, components, parts, or combinations thereof.

In describing the embodiments disclosed herein, when it is determined that a detailed description of related publicly known techniques may obscure the gist of the embodiments disclosed in this specification, the detailed description thereof will be omitted.

The present disclosure proposes a hidden-type cup holder device configured to enable a vehicle occupant to fully use a storage space formed in a console during normal operation and to deploy, in response to a button-pressing operation by the vehicle occupant, a hidden cup holder from a bottom portion of the storage space when necessary.

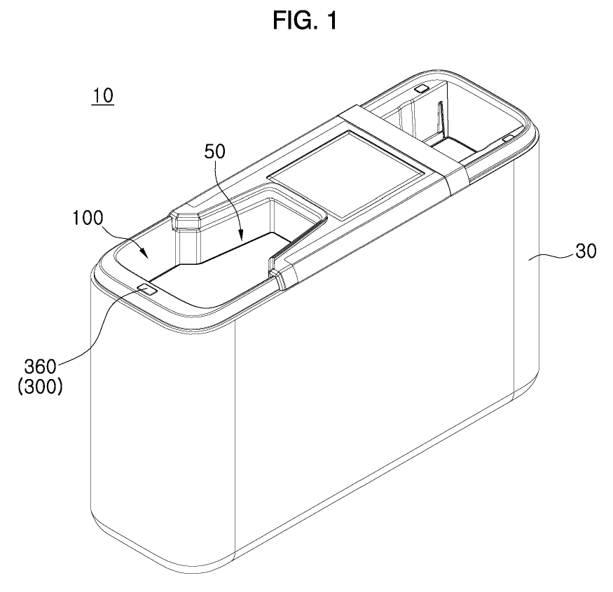

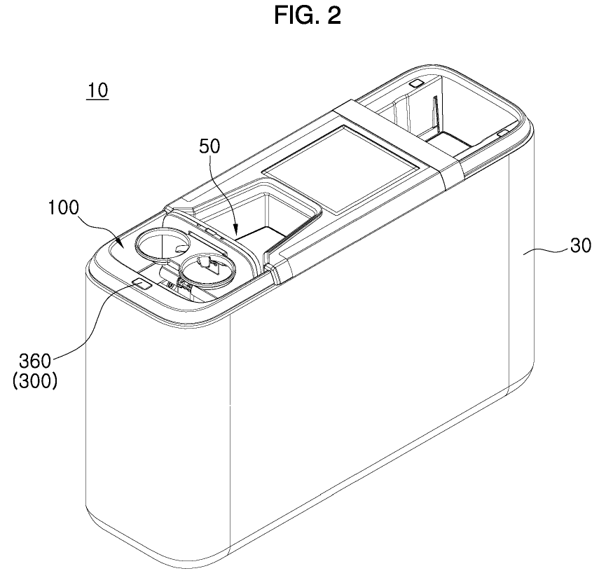

FIGS. 1 and 2 are views each showing an example of a console system according to the present disclosure.

FIG. 1 is a view showing an example of a normal state in which a cup holder is not deployed in the console system according to the present disclosure, and FIG. 2 is a view showing an example of a state in which the cup holder is deployed in the console system according to the present disclosure.

A console system 10 may be disposed inside a vehicle. The console system 10 may include a console device 30. For example, the console device 30 may have an internal storage space configured to accommodate an item therein and may also have various devices mounted therein and configured to improve passenger convenience, such as a cup holder, a refrigerator, a table, and a display.

For example, the console device 30 may be fixedly disposed between the driver-side seat and the passenger-side seat. Alternatively, the console device 30 may be movable through a rail device (not shown). Particularly, with advances in autonomous driving technology, the console device 30 may be disposed at various locations inside the vehicle and may be moved as necessary.

In the present disclosure, the console device 30 may include a cup holder device 100. The cup holder device 100 may include a storage space 50 adapted to store an item therein and may include a cup holder deployed from a bottom portion of the storage space 50.

Particularly, in the cup holder device 100 of the present disclosure, the cup holder is normally hidden without occupying the item storage space 50 such that the entirety of the storage space 50 is fully used. Here, the cup holder may be deployed in response to operation by a vehicle occupant when necessary.

For example, as shown in FIG. 1, the cup holder of the cup holder device 100 is normally hidden, thereby enabling a vehicle occupant to fully use the storage space 50 without the cup holder being visually recognized.

When the cup holder is required by the vehicle occupant, the cup holder may be deployed from the bottom portion of the storage space 50 by operating a main button 360 of a main switch unit 300 provided in the cup holder device 100, as shown in FIG. 2.

Preferably, the cup holder may be deployed from a part of the storage space 50. In the storage space 50, a remaining space other than the space in which the cup holder is deployed may still be used as a storage space for items.

Furthermore, when the cup holder of the cup holder device 100 is deployed in a state in which items are stored in the item storage space 50, the items stored in an upper space in which the cup holder of the cup holder device 100 is deployed may be pushed by deployment of the cup holder and may be stored in another space of the item storage space 50 other than the space in which the cup holder is deployed.

The hidden-type cup holder device 100 according to the present disclosure will be described in more detail through an embodiment.

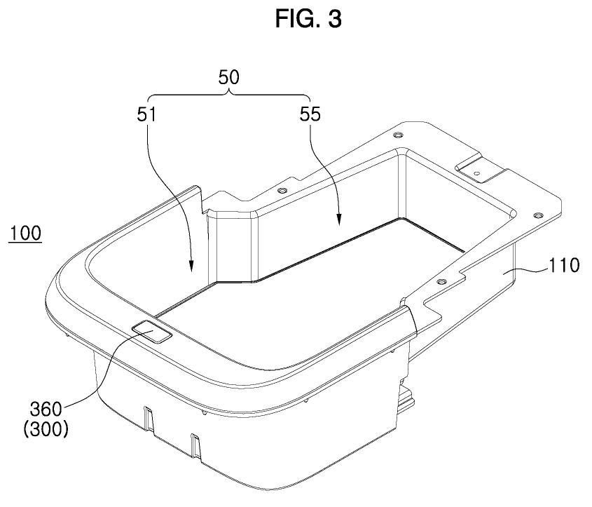

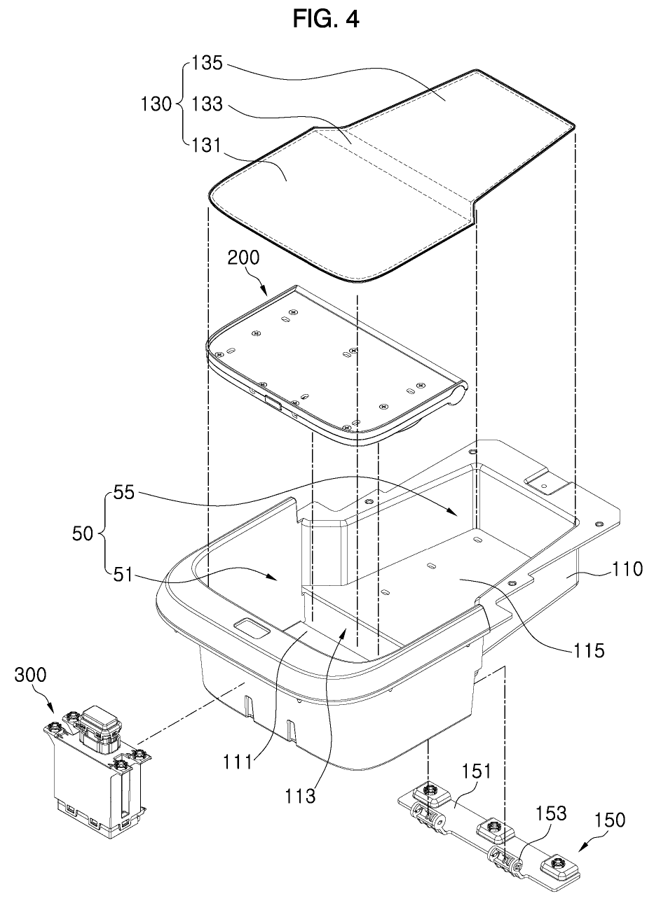

FIG. 3 is a view showing an embodiment of the cup holder device according to the present disclosure, and FIG. 4 is an exploded view of main components of the embodiment of the cup holder device according to the present disclosure.

The cup holder device 100 may include a housing 110, a base unit 200, the main switch unit 300, a skin member 130, and the like.

The housing 110 may be fixedly mounted on the console device 30.

The housing 110 may provide the item storage space 50. For example, the item storage space 50 may include a first space area 51 and a second space area 55.

The first space area 51 may be formed to correspond to the shape of the base unit 200. The second space area 55 may be formed in various shapes as needed.

The first space area 51 and the second space area 55 may form the single item storage space 50. For example, a space-limiting structure may not be provided between the first space area 51 and the second space area 55, and the first space area 51 and the second space area 55 may be connected to each other to form the single item storage space 50.

The housing 110 may include a base unit mounting part 111 having a recessed lower portion located at a lower portion of the first space area 51. The base unit 200 may be positioned on the base unit mounting part 111 provided at the lower portion of the first space area 51. An upper surface of the base unit 200 may form a bottom surface of the first space area 51.

When the base unit 200 is mounted on the bottom portion of the first space area 51, the upper surface of the base unit 200 and a bottom surface 115 of the second space area 55 in the housing 110 are connected to each other at the same height, thereby forming a bottom surface of the item storage space 50. That is, the upper surface of the base unit 200 and the bottom surface 115 of the housing 110 may form the flat bottom surface of the single item storage space 50.

A support member 150 may be mounted on an underside of the bottom surface 115 forming the second space area 55 of the housing 110. The support member 150 may include a support plate 151 fixedly mounted on the underside of the bottom surface 115 of the housing 110, and a base unit coupling part 153 formed to extend toward one side of the support plate 151 and coupled to the base unit 200. Alternatively, the base unit coupling part 153 may extend from a support plate 151 and be coupled to the base unit.

The support plate 151 of the support member 150 may be mounted on the underside of the bottom surface 115 of the housing 110 using various fastening methods such as bolt fastening.

A step may be formed between the bottom surface 115 of the housing 110 and the base unit mounting part 111, the step being defined by a height difference therebetween, and a support member mounting hole 113 may be formed in the step.

The base unit coupling part 153 of the support member 150 may be coupled to the base unit 200 positioned on the base unit mounting part 111 through the support member mounting hole 113, and the base unit 200 may be supported on the housing 110 through the support member 150.

A cup holder unit 400 may be mounted on the base unit 200.

The base unit 200 may be supported by the base unit coupling part 153 of the support member 150 and may be rotated upwards. For example, one end of the base unit 200 may be supported by the base unit coupling part 153 of the support member 150, and an opposite end of the base unit 200 may be rotated by a first predetermined angle so as to be erected in the storage space 50 in the housing 110.

The main switch unit 300 may be mounted on one side of the housing 110 and may selectively control rotational movement of the base unit 200.

The skin member 130 may be mounted in the bottom surface of the item storage space 50.

For example, the skin member 130 may include a first skin area 131 corresponding to the bottom of the first space area 51 and a second skin area 135 corresponding to the bottom of the second space area 55. Furthermore, the skin member 130 may include a connection area 133 connecting the first skin area 131 to the second skin area 135.

The lower surface of the first skin area 131 may be fixedly in contact with an upper surface of the base unit 200, and a lower surface of the second skin area 135 may be fixedly in contact with the bottom surface 115 of the housing 110.

The entirety of the skin member 130 may be formed of a flexible material. Alternatively, only the connection area 133 of the skin member 130 may be formed of a flexible material. In any case, the upper surface of the skin member 130 may be integrally formed to be flat by connecting all the surfaces of the skin member to each other. The connection area 133 of the skin member 130 may be bent in response to rotation of the base unit 200, thereby supporting rotation of the base unit 200.

Furthermore, since the bottom of the item storage space 50 is formed of the single skin member 130, the item storage space 50 is used as one overall space, and the vehicle occupant does not visually recognize the cup holder device 100. Accordingly, it is possible not only to provide an efficient item storage space with a simple design, but also to deploy the cup holder as necessary, thereby achieving enhancement of a vehicle.

Hereinafter, a detailed configuration of the cup holder device according to the present disclosure will be described with reference to an embodiment.

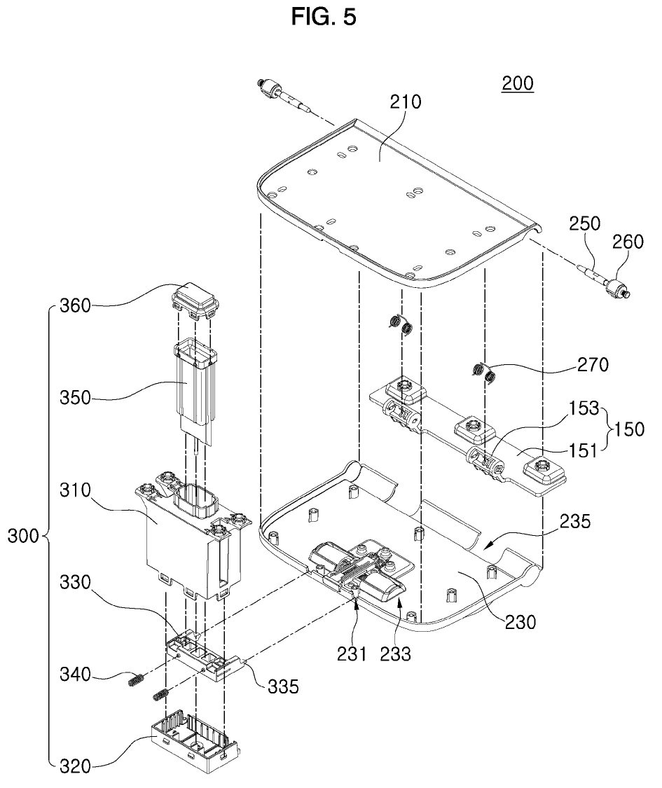

FIGS. 5 and 6 are exploded views of an embodiment of a base unit and a main switch unit of the cup holder device according to the present disclosure.

FIG. 5 is an exploded view of the embodiment of the base unit and the main switch unit when viewed from the upper side, and FIG. 6 is an exploded view of the embodiment of the base unit and the main switch unit when viewed from the lower side.

The base unit 200 may include an upper plate 210, a lower plate 230, a base rotation means, and the like.

The upper plate 210 and the lower plate 230 may be coupled to each other in a corresponding manner to form the body of the base unit 200.

The upper plate 210 may have a base rotation means mounting part 211 provided on an inner surface of a rear portion thereof, and the lower plate 230 may have a support member coupling hole 235 opening at a rear side surface thereof and receiving a part of the base unit coupling part 153 of the support member 150. The support member coupling hole 235 may be embodied as a cutout, a through-hole, or the like

The base rotation means may include a base rotation shaft 250, a base elastic member 270, a base rotation damper 260, and the like.

The base rotation shaft 250 may be mounted on the base rotation means mounting part 211 and the base unit coupling part 153 of the support member 150. The base rotation shaft 250 may have one portion fixed to the base rotation means mounting part 211 and another portion rotatably mounted on the base unit coupling part 153.

The base rotation shaft 250 may have the base elastic member 270 mounted thereon. For example, the base elastic member 270 may be a torsion spring. One end of the base elastic member 270 may be fixedly connected to the base rotation shaft 250, and the other end thereof may be fixedly connected to the base unit coupling part 153 of the support member 150. Elastic force of the torsion spring may be accumulated and increased by external force, and the base rotation shaft 250 may be rotated by restoring force of the torsion spring.

Furthermore, a base rotation damper 260 may be mounted on the base rotation shaft 250 to control, at a predetermined level, the rotation speed of the base rotation shaft 250 by the base elastic member 270. For example, the base rotation damper 260 may be an oil damper. In this case, oil filling the inside of the oil damper allows the base rotation shaft 250 to be smoothly rotated at a constant speed in a state in which the rotation speed of the base rotation shaft 250 does not exceed the predetermined level.

Preferably, the upper plate 210 has the base rotation means mounting parts 211 respectively provided on both left and right sides thereof, and the lower plate 230 may have the support member coupling holes 235 respectively provided in both left and right sides thereof. Here, the support member 150 may have the base unit coupling parts 153 respectively provided on both left and right sides thereof. Accordingly, the base rotation means may be mounted on both left and right sides.

The lower plate 230 may have a cup holder unit mounting hole 233 formed to penetrate a part thereof, and a cup holder unit 400 may be mounted in a portion of the cup holder unit mounting hole 233. Furthermore, a cup holder switch mounting part 217 may be provided on a portion of the inner surface of the upper plate 210, which corresponds to the cup holder unit mounting hole 233, thereby enabling a cup holder switch unit to be mounted on the cup holder switch mounting part 217.

The cup holder unit 400 may be mounted in a portion of the cup holder unit mounting hole 233 in the lower plate 230.

The cup holder unit 400 may be rotatably deployed while being supported by the base unit 200, which will be described in a later embodiment.

A base locking hole 231 may be provided in the front side surface of the lower plate 230. A base locking protrusion 335 of the main switch unit 300 may be selectively inserted into or withdrawn from the base locking hole 231.

The main switch unit 300 may include a main switch upper body 310, a main switch lower body 320, a main locking member 330, a main switch elastic member 340, a main operation member 350, and a main button 360.

The main switch upper body 310 and the main switch lower body 320 may be coupled to each other in a corresponding manner. The main operation member 350 may be mounted to be vertically movable upwards and downwards through the main switch upper body 310. The main locking member 330 may be mounted on the main switch lower body 320 so as to be horizontally movable forwards and backwards.

The base locking protrusion 335 may be provided at the front end of the main locking member 330.

One end of the main switch elastic member 340 may be fixedly supported by the main switch lower body 320, and the other end thereof may be connected to the rear side surface of the main locking member 330. Elastic force of the main switch elastic member 340 may be accumulated and increased by external force applied to the main switch elastic member, and the main locking member 330 may be horizontally moved by restoring force of the main switch elastic member 340.

The main button 360 may be coupled to the upper end of the main operation member 350, and the lower end of the main operation member 350 may be in contact with the main locking member 330.

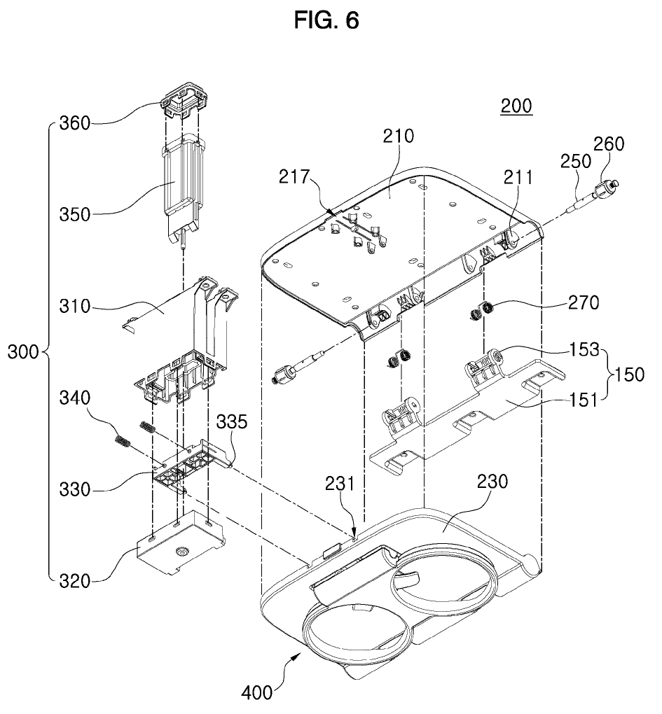

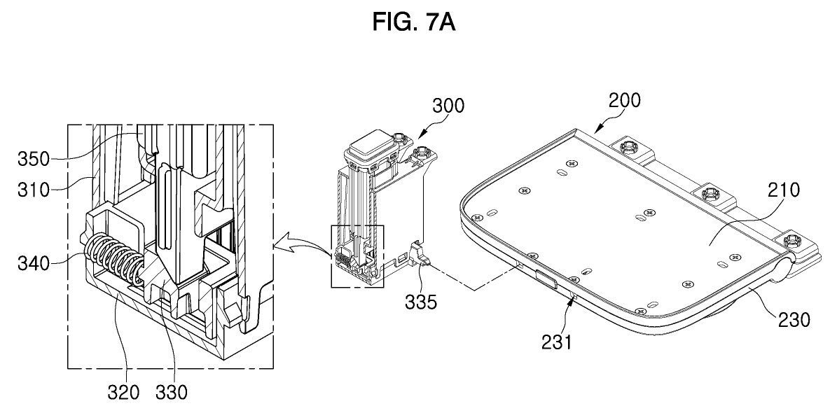

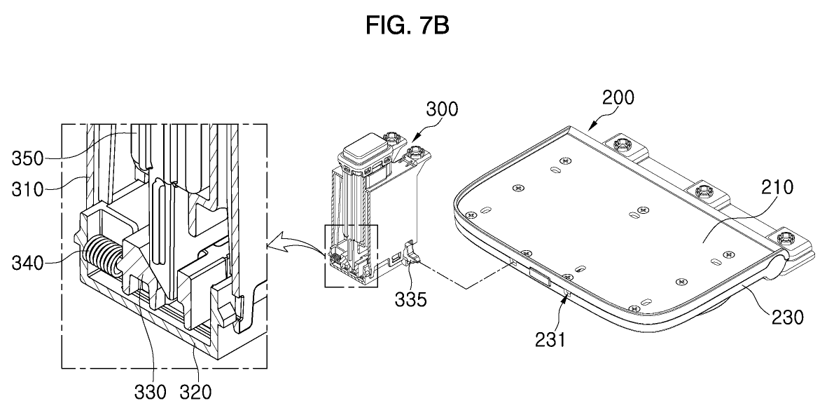

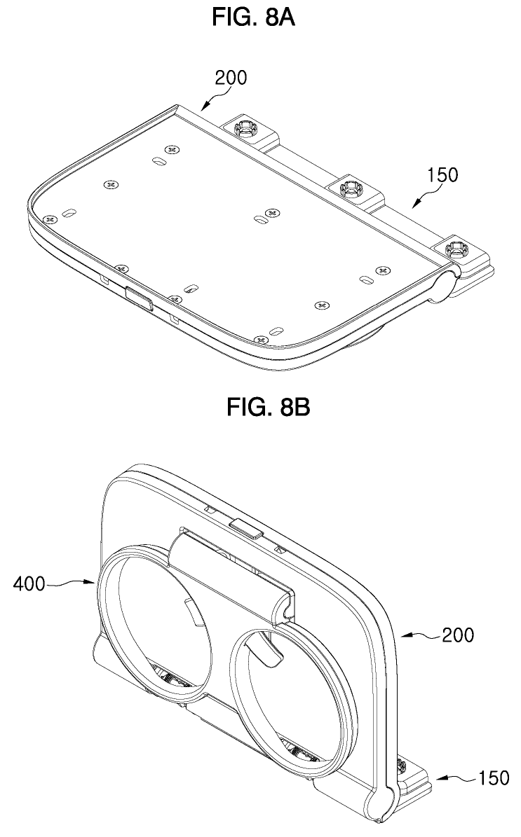

FIGS. 7A-7B are exemplary operational views of the main switch unit of the cup holder device according to the present disclosure, and FIGS. 8A-8B are exemplary operational views of the base unit of the cup holder device according to the present disclosure. A detailed description will be given with reference to FIGS. 7A-7B and 8A-8B.

The lower end of the main operation member 350 may be provided with a first inclined surface that is inclined in the diagonal direction, and the middle portion of the main locking member 330 may be provided with a second inclined surface that is inclined in the diagonal direction and corresponds to the first inclined surface of the main operation member 350.

The first inclined surface of the main operation member 350 and the second inclined surface of the main locking member 330 may be maintained in contact with each other.

FIG. 7A is a view showing a normal state in which the main switch unit 300 is not operated, and the main locking member 330 may be maintained in a state in which the main locking member 330 is horizontally moved forwards by the main switch elastic member 340.

In a state in which the main locking member 330 is horizontally moved forwards, the first inclined surface of the main operation member 350 is pushed upwards along the second inclined surface of the main locking member 330, and the main button 360 located at the upper end of the main operation member 350 may be positioned at the uppermost point.

Furthermore, in a state in which the main locking member 330 is horizontally moved forwards, the base locking protrusion 335 may be inserted into and coupled to the base locking hole 231 in the base unit 200.

In a state in which elastic force of the base elastic member 270 provided on the base unit 200 is accumulated and increased, the base locking protrusion 335 is inserted into and coupled to the base locking hole 231 in the base unit 200, thereby restricting rotation of the base unit 200 due to restoring force of the base elastic member 270.

In a state in which rotation of the base unit 200 is restricted by the main switch unit 300, as shown in FIG. 8A, a lying state of the base unit 200 may be maintained in a state in which base unit 200 is supported by the support member 150.

FIG. 7B is a view showing a state in which a vehicle occupant operates the main switch unit 300. In this case, when the vehicle occupant presses the main button 360 downwards, the main operation member 350 is pushed downwards, and the second inclined surface of the main locking member 330 is pushed rearwards in the horizontal direction along the first inclined surface of the main operation member 350. Accordingly, the main locking member 330 may be horizontally moved rearwards.

When the main locking member 330 is horizontally moved rearwards, the base locking protrusion 335 may be withdrawn from the base locking hole 231 in the base unit 200, and the base unit 200 may be rotated by restoring force of the base elastic member 270 provided in the base unit 200.

In this manner, in response to the operation by the vehicle occupant with respect to the main switch unit 300, the base unit 200 may be supported by the support member 150 and may be rotated by restoring force of the base elastic member 270. In this manner, the base unit 200 may stand upright, as shown in FIG. 8B.

Furthermore, when the main locking member 330 is horizontally moved rearwards, elastic force is accumulated and increased in the main switch elastic member 340. When the vehicle occupant stops the operation of pressing the main button 360 downwards, the main locking member 330 is horizontally moved forwards by restoring force of the main switch elastic member 340. In response thereto, the main operation member 350 is pushed upwards such that the main button 360 returns to the uppermost point.

Additionally, when the base unit 200 is rotated by external force of the vehicle occupant, elastic force of the base elastic member 270 provided in the base unit 200 is accumulated and increased, and the base locking protrusion 335 is inserted into and coupled to the base locking hole 231 in the base unit 200. Then, as shown in FIG. 7A, rotation of the base unit 200 is restricted, and as shown in FIG. 8A, the base unit 200 maintains the lying state thereof while being supported by the support member 150.

The cup holder unit 400 may be deployed in a state in which the base unit 200 is in the upright state while being supported by the support member 150. The cup holder unit 400 will be described below through an embodiment.

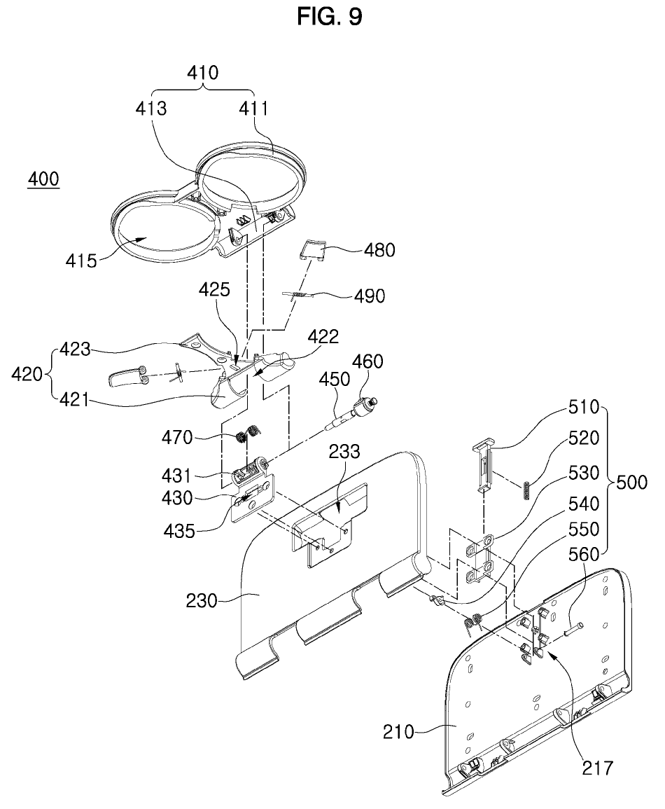

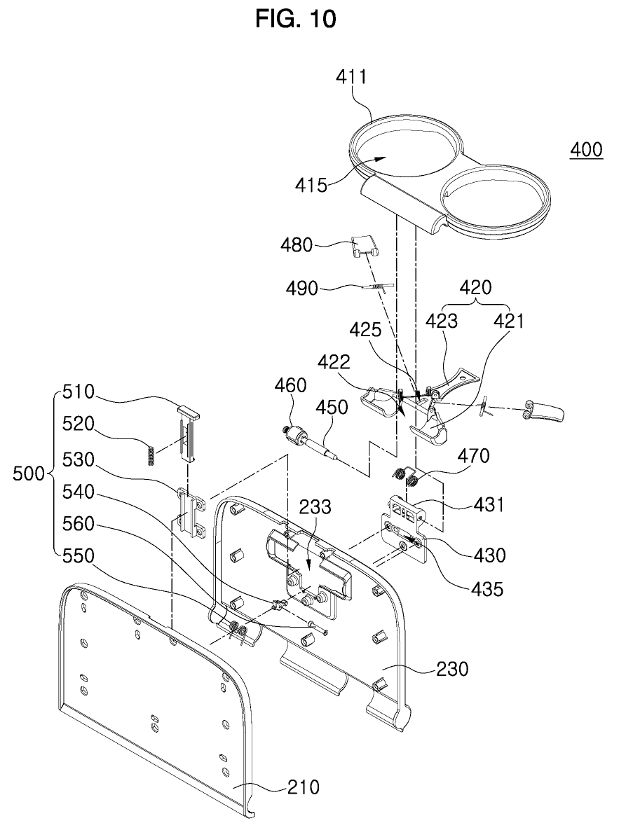

FIGS. 9 and 10 are exploded views of an embodiment of the base unit and the cup holder unit of the cup holder device according to the present disclosure.

FIG. 9 is an exploded view of the embodiment of the base unit and the cup holder unit when viewed from the lower side, and FIG. 10 is an exploded view of the embodiment of the base unit and the cup holder unit when viewed from the upper side.

The cup holder unit 400 may include a cup holder body 410, a cup holder lower case 420, a cup holder fixing member 430, a cup holder rotation means, a cup support means, and the like.

The cup holder body 410 includes a cup grip part 411, and a cup support space 415 may be formed by penetrating a center portion of the cup grip part 411. For example, the cup support space 415 may be formed to have a circular shape configured for a cup to be inserted thereinto and supported therein. Two cup support spaces 415 may be provided on both left and right sides of the cup holder body 410.

A cup holder rotation means mounting part 413 may be provided on an inner surface of a rear portion of the cup holder body 410.

The cup holder lower case 420 may include a cup holder body mounting part 423, a cup holder rotation means cover part 421, and the like.

The cup holder body mounting part 423 may be coupled to the lower surface of the cup holder body 410. For example, the cup holder body mounting part 423 may be formed in shape that does not to protrude toward the cup support space 415 in the cup holder body 410.

A cup holder locking hole 425 may be provided in the cup holder body mounting part 423. A cup holder locking protrusion 541 of a cup holder switch unit 500 may be selectively locked in or unlocked from the cup holder locking hole 425.

The cup support means may be coupled to the cup holder body mounting part 423. The cup support means may be coupled to the cup holder body mounting part 423 and oriented toward the cup support space 415 to maintain the position of the cup inserted into and stored in the cup support space 415.

For example, when two cup support spaces 415 are provided on both sides of the cup holder body 410, the cup support means may be coupled to each cup holder body mounting part 423 and may be oriented toward each cup support space 415.

The cup support means may include a cup support stub 480, a cup support elastic member 490, and the like. The end of the cup support stub 480 may be rotatably mounted on the cup holder body mounting part 423. One side of the cup support elastic member 490 may be connected to the cup support stub 480, and the other side thereof may be connected to the cup holder body mounting part 423.

When a cup is inserted into and stored in the cup support space 415, the outer surface of the cup contacts the cup support stub 480, and the cup support stub 480 may push the cup by elastic force of the cup support elastic member 490, thereby maintaining the position of the cup in the cup support space 415.

The cup holder rotation means cover part 421 may have a mounting space provided therein and configured for the cup holder rotation means to be mounted therein. Furthermore, the cup holder rotation means cover part 421 may have a cup holder fixing member coupling hole 422 opening at the rear side surface of the cup holder rotation means cover part 421, and a part of the cup holder fixing member 430 may be inserted into the cup holder fixing member coupling hole 422. The coupling hole 422 may be embodied as a cutout, a through-hole, or the like.

The cup holder fixing member 430 may be fixedly mounted on the lower plate 230 of the base unit 200. For example, the cup holder fixing member 430 may be mounted in the cup holder unit mounting hole 233 provided in the lower plate 230 of the base unit 200.

The cup holder fixing member 430 may be provided with a cup holder elastic member mounting part 431. The cup holder elastic member mounting part 431 of the cup holder fixing member 430 may be inserted into the cup holder fixing member coupling hole 422 in the cup holder rotation means cover part 421.

The cup holder rotation means may include a cup holder rotation shaft 450, a cup holder elastic member 470, a cup holder rotation damper 460, and the like.

The cup holder rotation shaft 450 may be mounted on the cup holder rotation means mounting part 413 of the cup holder body 410 and the cup holder elastic member mounting part 431 of the cup holder fixing member 430. The cup holder rotation shaft 450 may have one portion fixed to the cup holder rotation means mounting part 413 and another portion rotatably mounted on the cup holder elastic member mounting part 431.

The cup holder elastic member 470 may be mounted on the cup holder rotation shaft 450. For example, a torsion spring may be used as the cup holder elastic member 470. One end of the cup holder elastic member 470 may be fixedly connected to the cup holder rotation shaft 450, and the other end thereof may be fixedly connected to the cup holder elastic member mounting part 431 of the cup holder fixing member 430. Elastic force of the torsion spring may be accumulated and increased by external force, and the cup holder rotation shaft 450 may be rotated by restoring force of the torsion spring.

Furthermore, the cup holder rotation damper 460 may be mounted on the cup holder rotation shaft 450 to control, at a predetermined level, rotation speed of the cup holder rotation shaft 450 by the cup holder elastic member 470. For example, the cup holder rotation damper 460 may be an oil damper, and oil filling the inside of the cup holder rotation damper 460 allows the cup holder rotation shaft 450 to be smoothly rotated at a constant speed in a state in which the rotation speed of the cup holder rotation shaft 450 does not exceed a predetermined level.

Furthermore, the cup holder fixing member 430 may be provided with a locking protrusion through-hole 435. The cup holder locking protrusion 541 of the cup holder switch unit 500 may pass through the locking protrusion through-hole 435 of the cup holder fixing member 430 and may be selectively locked in or unlocked from the cup holder locking hole 425 provided in the cup holder lower case 420.

The cup holder switch unit 500 may include a cup holder deployment operation member 510, a cup holder button elastic member 520, a cup holder switch body 530, a cup holder locking member 540, a cup holder locking elastic member 550, and a cup holder locking rotation shaft 560.

The cup holder switch body 530 may be fixedly mounted on a cup holder switch mounting part 217 provided on the inner surface of the upper plate 210 of the base unit 200.

The cup holder switch body 530 may be provided with a guide groove recessed inwards in the longitudinal direction, and vertical movement of the cup holder deployment operation member 510 may be guided along the guide groove in the cup holder switch body 530.

The cup holder deployment operation member 510 may have an upper end exposed to the outside and configured to serve as a cup holder deployment button and may have a lower end disposed to be in contact with the cup holder locking member 540. In response to pressing operation by the vehicle occupant, the cup holder deployment operation member 510 may be moved downwards along the guide groove of the cup holder switch body 530, thereby operating the cup holder locking member 540.

The cup holder button elastic member 520 may have one end connected to the cup holder deployment operation member 510 and the other end connected to the cup holder switch body 530. When the cup holder deployment operation member 510 is moved downwards in response to the pressing operation by the vehicle occupant, elastic force of the cup holder button elastic member 520 is accumulated and increased. When the pressing operation by the vehicle occupant is released, the cup holder button elastic member 520 uses restoring force thereof to push the cup holder deployment operation member 510 upwards. Accordingly, the upper end of the cup holder deployment operation member 510 functioning as a cup holder deployment button may be positioned at the uppermost point.

The cup holder locking member 540 may be rotatably mounted on the cup holder locking rotation shaft 560. The cup holder locking rotation shaft 560 may be mounted on the cup holder switch mounting part 217 provided on the inner surface of the upper plate 210 of the base unit 200.

The cup holder locking member 540 and the cup holder locking elastic member 550 may be mounted on the cup holder locking rotation shaft 560.

The cup holder locking elastic member 550 may have one end connected to the cup holder switch mounting part 217 of the upper plate 210 and the other end connected to the cup holder locking member 540. For example, the cup holder locking elastic member 550 may be a torsion spring. Elastic force of the torsion spring may be accumulated and increased by external force, and the cup holder locking elastic member 550 may be rotated by restoring force of the torsion spring.

When the cup holder deployment operation member 510 is moved downwards, the cup holder locking member 540 may be pushed downwards, and thus the cup holder locking member 540 may be rotated while being supported by the cup holder locking rotation shaft 560.

For example, when the cup holder deployment operation member 510 is moved in response to the pressing operation by the vehicle occupant, the cup holder locking member 540 is rotated, and elastic force of the cup holder locking elastic member 550 may be accumulated and increased by rotational force of the cup holder locking member 540.

The cup holder locking member 540 may have the cup holder locking protrusion 541 provided on one side surface thereof and formed to protrude outwards. The cup holder locking protrusion 541 may be selectively locked in or unlocked from the cup holder locking hole 425 provided in the cup holder lower case 420 by passing through the locking protrusion through-hole 435 in the cup holder fixing member 430.

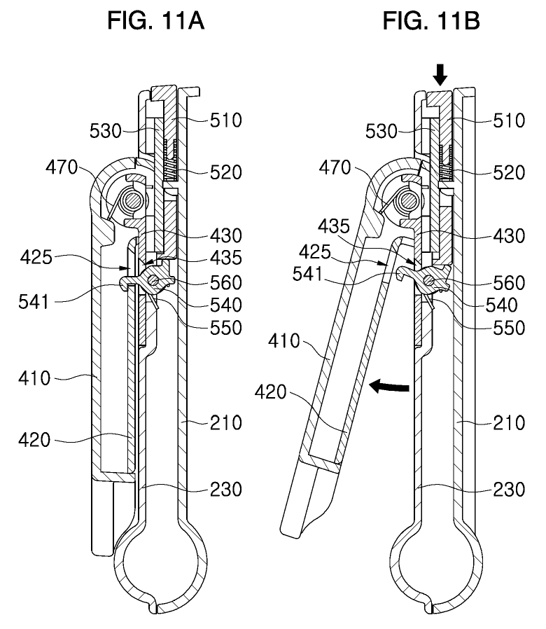

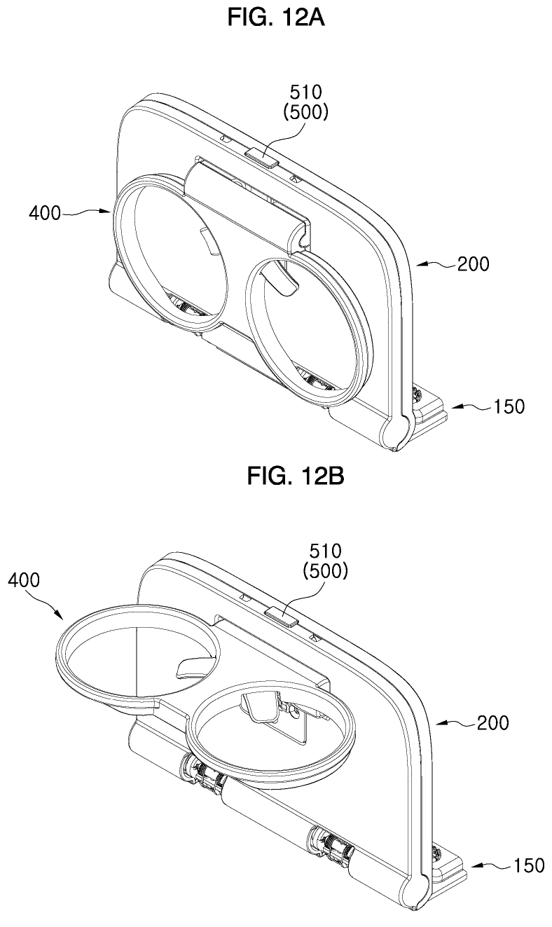

FIGS. 11A-11B are exemplary cross-sectional operational views of the cup holder unit of the cup holder device according to the present disclosure, and FIGS. 12A-12B are exemplary operation views of the cup holder unit of the cup holder device according to the present disclosure.

FIG. 11A is a cross-sectional view showing a state in which the cup holder unit 400 is not deployed from the base unit 200, and FIG. 11B is a cross-sectional view showing a state in which the cup holder unit 400 is deployed from the base unit 200.

As shown in FIG. 11A and FIG. 12A, in a state in which the cup holder unit 400 is not deployed from the base unit 200, elastic force of the cup holder elastic member 470 of the cup holder unit 400 is in a state of being accumulated and increased. In this state, the cup holder locking protrusion 541 of the cup holder switch unit 500 may be locked in and coupled to the cup holder locking hole 425 in the cup holder unit 400.

As shown in FIG. 11B and FIG. 12B, when the vehicle occupant presses the cup holder deployment button provided at the upper end of the cup holder deployment operation member 510 of the cup holder switch unit 500, the cup holder deployment operation member 510 is pushed downwards, thereby rotating the cup holder locking member 540 in contact with the lower end of the cup holder deployment operation member 510.

When the cup holder locking member 540 is rotated, the cup holder locking protrusion 541 of the cup holder switch unit 500, which is locked in and coupled to the cup holder locking hole 425 in the cup holder unit 400, is unlocked from the cup holder locking hole 425. Accordingly, elastic force accumulated in the cup holder elastic member 470 of the cup holder unit 400 acts as restoring force, thereby enabling the cup holder unit 400 to be rotatably deployed from the base unit 200.

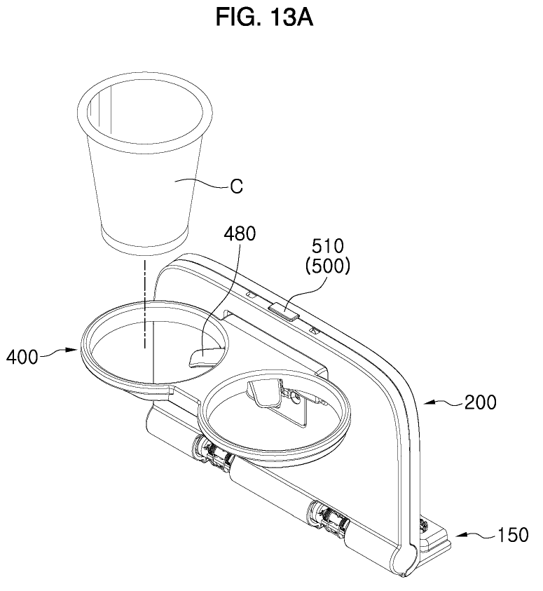

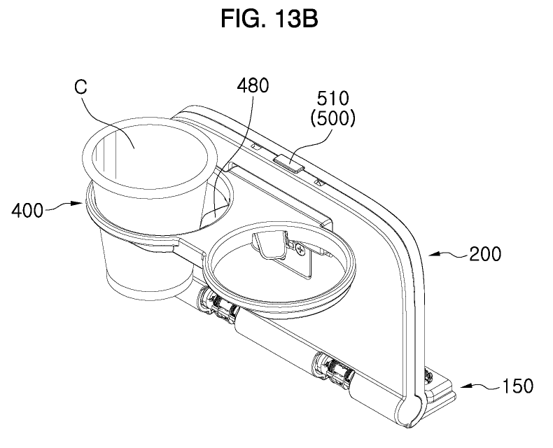

FIGS. 13A-13B are views showing an example of storing a cup in the cup holder device according to the present disclosure.

When a cup is stored in the cup holder unit 400 deployed from the base unit 200, as shown in FIG. 13A, the cup may be inserted into the cup support space 415 and may be stored in the cup holder unit 400, as shown in FIG. 13B. In this case, the cup support stub 480 of the cup support means contacts one side of the stored cup and pushes the same to maintain the position of the cup in the cup support space 415.

Furthermore, as described above, while the base unit 200 is erected upwards in the first space area 51 of the item storage space 50 in the cup holder device 100, the cup holder unit 400 is deployed from the base unit 200. In this case, when the base unit 200 is rotated beyond a predetermined level due to various factors such as external force applied to the base unit 200 by the vehicle occupant, the cup holder unit 400 may be inappropriately positioned such that the cup is not appropriately stored in the cup holder unit 400, and furthermore, the cup holder device 100 may be damaged.

To address the above-mentioned problems, the cup holder device 100 may be provided with a stopper means configured to restrict rotation of the base unit 200 beyond a set range.

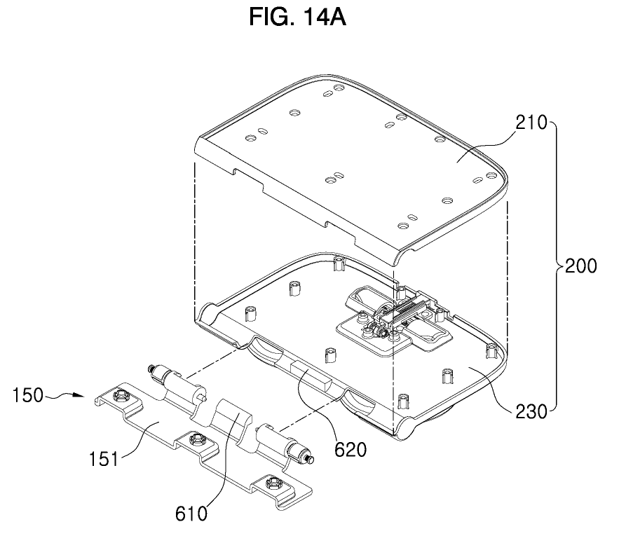

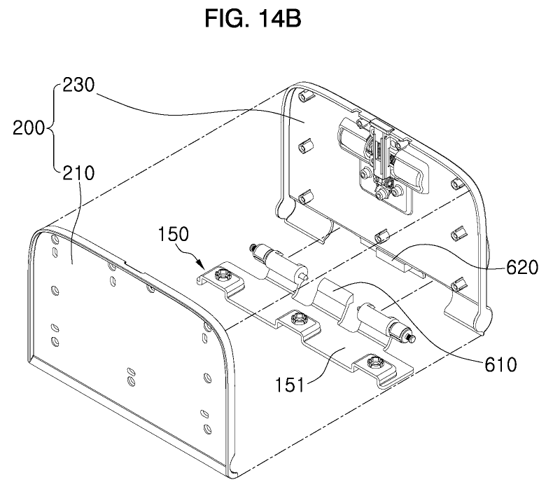

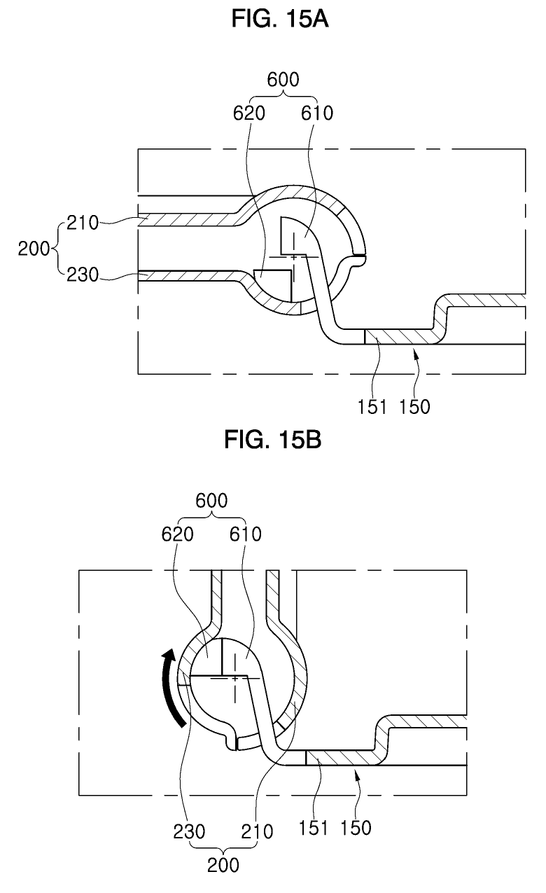

FIGS. 14A-14B are views showing an example of the cup holder device including the stopper means according to the present disclosure, and FIGS. 15A-15B are views showing a cross-sectional operational view of an exemplary stopper means of the cup holder device according to the present disclosure.

A stopper means 600 may include a first stopper member 610 and a second stopper member 620. When the base unit 200 is erected while being supported by the support member 150, the first stopper member 610 and the second stopper member 620 may contact each other to restrict further rotation of the base unit 200.

The support member 150 may include the first stopper member 610.

The first stopper member 610 may extend from the support plate 151 in the same direction as the base unit coupling part 153. For example, the first stopper member 610 may be formed between the base unit coupling parts 153 respectively disposed on both sides of the support plate 151. The end surface of the first stopper member 610 may be formed to have a flat surface corresponding to the base unit 200 in the erected state.

Furthermore, the base unit 200 may include the second stopper member 620.

The second stopper member 620 may be formed to protrude from the end portion of an inner surface of a rear portion of the lower plate 230. For example, the second stopper member 620 may be formed between the support member coupling holes 235 respectively formed in both sides of the lower plate 230. The end surface of the second stopper member 620 may be formed to have a flat surface so as to contact the end surface of the first stopper member when the base unit 200 is erected.

In the normal state before the base unit 200 is rotated and erected, as shown in FIG. 15A, the first stopper member 610 and the second stopper member 620 are spaced apart from each other and do not contact each other.

In a state in which the base unit 200 is rotated and erected in response to the operation by the vehicle occupant with respect to the main switch unit 300, as shown in FIG. 15B, when the lower plate 230 is rotated, the second stopper member 620 is rotated, and the end surface of the first stopper member 610 and the end surface of the second stopper member 620 correspond to each other and contact each other.

Since the support member 150 is in the fixed state, the first stopper member 610 extending from the support member 150 restricts rotation of the second stopper member 620, thereby preventing further rotation of the second stopper member 620. Accordingly, rotation of the base unit 200 may also be restricted.

Furthermore, the cup holder device 100 may include a cup holder deployment light-emitting means configured to enable the vehicle occupant to check whether the cup holder is deployed in a condition appropriate for storing the cup and to visually recognize the position of the cup holder.

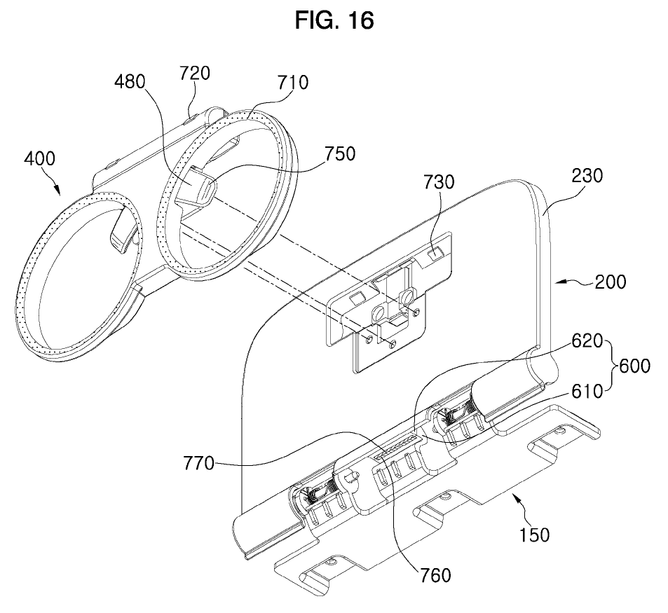

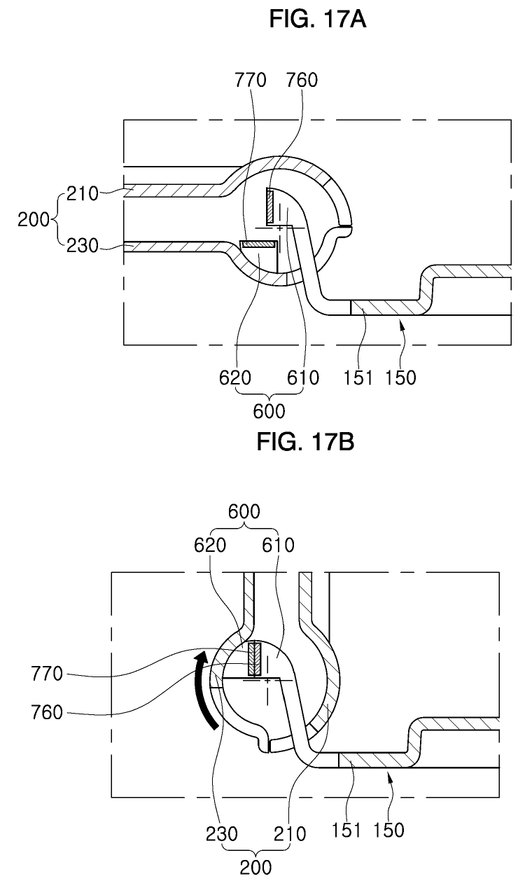

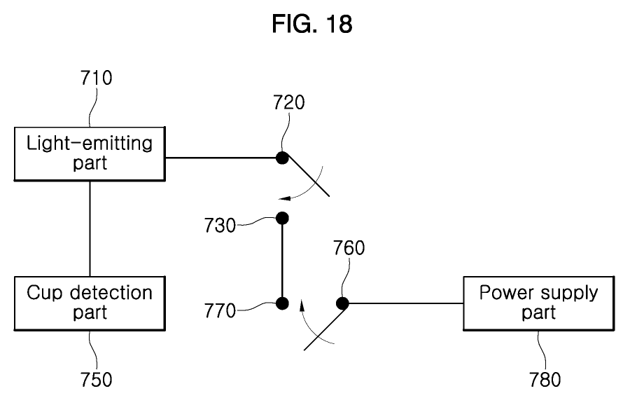

FIG. 16 is a view showing an embodiment of the cup holder deployment light-emitting means of the cup holder device according to the present disclosure, FIG. 17 is a cross-sectional operational view of an exemplary lower contact terminal of the cup holder deployment light-emitting means of the cup holder device according to the present disclosure, and FIG. 18 is a view showing an exemplary equivalent circuit of the cup holder deployment light-emitting means of the cup holder device according to the present disclosure.

The cup holder deployment light-emitting means may include a light-emitting part 710, upper contact terminals 720 and 730, lower contact terminals 760 and 770, and a power supply part 780. Furthermore, the cup holder deployment light-emitting means may further include a cup detection part 750.

The light-emitting part 710 may be provided on the cup holder unit 400 and may emit light when the base unit 200 is appropriately erected and the cup holder unit 400 is appropriately deployed. For example, the light-emitting part 710 may emit light when the cup holder unit 400 is deployed within a predetermined range suitable for storing the cup. Alternatively, the light-emitting part 710 may only emit light when the base unit 200 is erected within a set angle range and the cup holder unit 400 is deployed within a set range suitable for storing the cup.

For example, the light-emitting part 710 includes a light-emitting element that emits light. Specifically, the light-emitting element of the light-emitting part 710 may be mounted on the cup holder body 410 along the outer circumference of the cup support space 415 of the cup holder unit 400.

The upper contact terminal may function as an electric switch electrically connected according to deployment of the cup holder unit 400.

For example, the upper contact terminal may include the upper first contact terminal 720 and the upper second contact terminal 730.

The upper first contact terminal 720 may be provided as an electrode terminal on the outer surface of the cup holder body 410 of the cup holder unit 400. The upper second contact terminal 730 may be provided as an electrode terminal on the inner surface of the cup holder unit mounting hole 233 in the lower plate 230.

The positions of the upper first contact terminal 720 and the upper second contact terminal 730 may be adjusted to allow the upper first contact terminal 720 and the upper second contact terminal 730 to contact each other when the cup holder unit 400 is deployed from the base unit 200 within a predetermined range. For example, when the cup holder unit 400 is deployed within a setting range suitable for storing a cup, the positions of the upper first contact terminal 720 and the upper second contact terminal 730 may be automatically selected such that the upper first contact terminal 720 and the upper second contact terminal 730 contact each other.

A lower contact terminal may function as a type of electric switch electrically connected when the base unit 200 is erected.

For example, the lower contact terminal may include a lower first contact terminal 760 and a lower second contact terminal 770.

The lower first contact terminal 760 may be provided as an electrode terminal on the end surface of the first stopper member 610 provided on the support member 150. The lower second contact terminal 770 may be provided as an electrode terminal on the end surface of the second stopper member 620 provided on the base unit 200.

The positions of the lower first contact terminal 760 and the lower second contact terminal 770 may be adjusted to allow the lower first contact terminal 760 and the lower second contact terminal 770 to contact each other when the base unit 200 is erected within a set range in a state of being supported by the support member 150. For example, when the cup holder unit 400 is deployed and the base unit 200 is erected within a predetermined range suitable for storing a cup, the positions of the lower first contact terminal 760 and the lower second contact terminal 770 may be automatically selected such that the lower first contact terminal 760 and the lower second contact terminal 770 contact each other.

The cup holder unit 400 may include an electrical line connecting the light-emitting part 710 to the upper first contact terminal 720, and the base unit 200 may include an electrical line connecting the upper second contact terminal 730 to the lower second contact terminal 770.

Furthermore, the housing 110 may include the power supply part 780 that supplies power, and the support member 150 and the housing 110 may include an electrical line connecting the lower first contact terminal 760 to the power supply part 780.

Additionally, the cup holder unit 400 may include the cup detection part 750 configured to detect whether a cup is stored in the cup support space 415.

For example, the cup detection part 750 may be a pressure sensor and may be provided on the upper surface of an end of the cup support stub 480 of the cup support means. When a cup is stored in the cup holder unit 400, the end of the cup support stub 480 contacts the cup and presses the cup detection part 750, thereby enabling the cup detection part 750 to detect whether the cup is stored in the cup holder unit.

The cup detection part 750 is electrically connected to the light-emitting part 710, and the light-emitting part 710 may include an electrical circuit that emits light having different colors depending on whether the cup detection part 750 detects the cup.

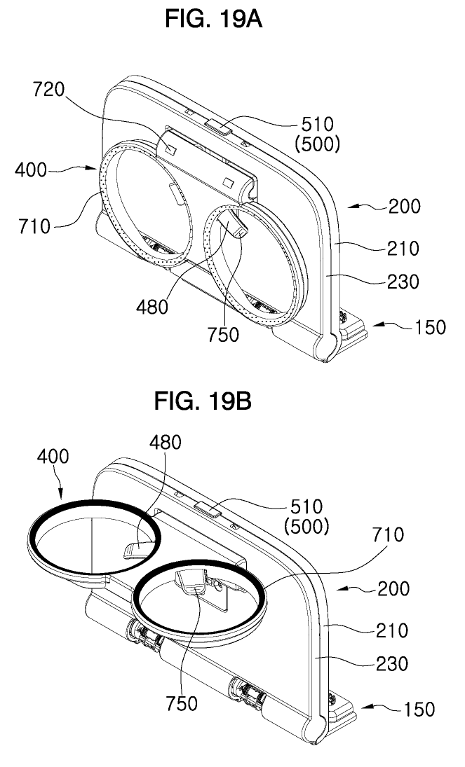

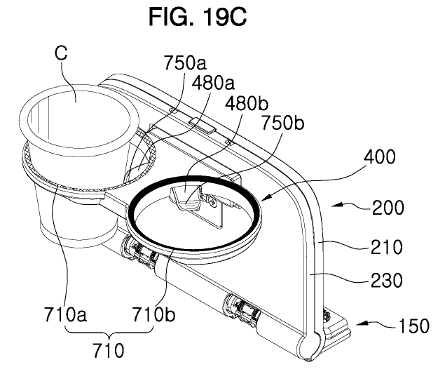

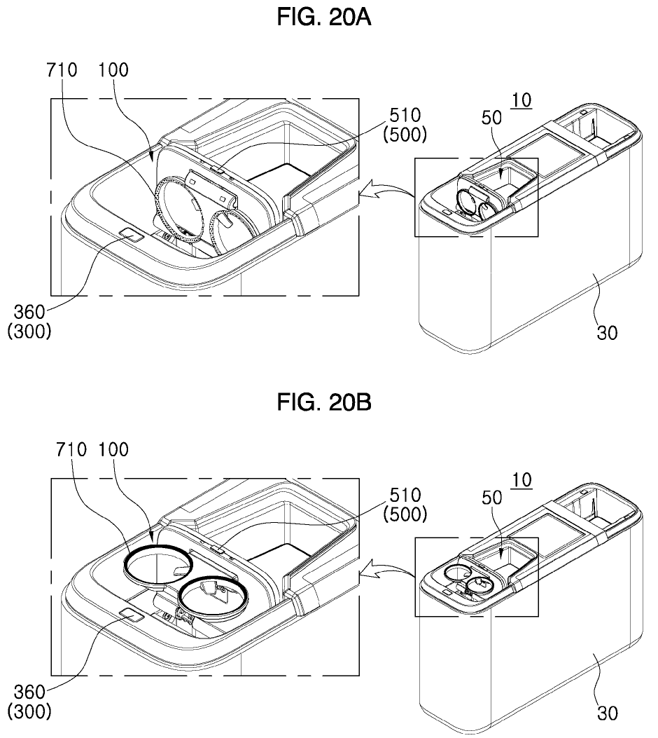

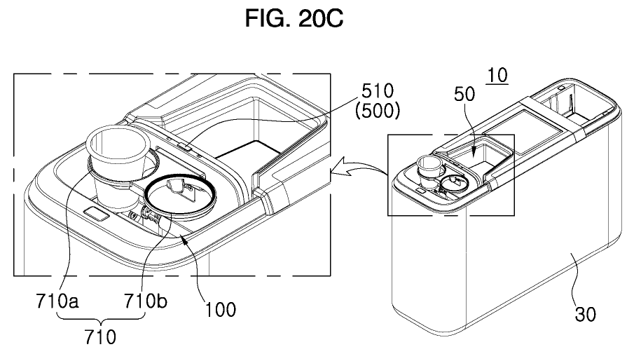

FIGS. 19A-19C and 20A-20C are operational views of an embodiment of the cup holder deployment light-emitting means of the cup holder device according to the present disclosure, and a description will be given with reference to FIGS. 19A-19C and 20A-20C.

The base unit 200 is erected in the item storage space 50 in the console device 30 when the vehicle occupant operates the cup holder deployment operation member 510 of the cup holder switch unit 500, as shown in FIG. 19A and FIG. 20A. In this case, the lower first contact terminal 760 and the lower second contact terminal 770 are in contact with each other and electrically connected to each other, but the upper first contact terminal 720 and the upper second contact terminal 730 are not in contact with each other. Therefore, power is not supplied to the light-emitting part 710, and the light-emitting part 710 does not emit light.

As shown in FIG. 19B and FIG. 20B, when the cup holder unit 400 is appropriately deployed in a state in which the base unit 200 is erected, the upper first contact terminal 720 and the upper second contact terminal 730 are also in contact with each other and electrically connected to each other in a state in which the lower first contact terminal 760 and the lower second contact terminal 770 are electrically connected to each other.

When both the upper contact terminals 720 and 730 and the lower contact terminals 760 and 770 are electrically connected to each other, power is supplied to the light-emitting part 710 via the power supply part 780, thereby enabling the light-emitting part 710 to emit light.

Furthermore, when a cup is inserted into and stored in the cup holder unit 400, the cup detection part 750 may detect presence of the cup.

For example, as shown in FIG. 19C and FIG. 20C, in a state in which the base unit 200 is appropriately erected and the cup holder unit 400 is appropriately deployed, when a cup C is inserted into and stored in the first cup support space of the first and second cup support spaces 415 of the cup holder unit 400, a first cup detection part 750a may detect presence of the cup C. After storage of the cup is detected, the light-emitting part 710 may emit light having a different color. That is, a first light-emitting part 710a corresponding to the first cup support space in which the cup is stored, and a second light-emitting part 710b corresponding to the second cup support space in which the cup is not stored may emit light having different colors.

According to the present disclosure, since a cup holder is completely hidden when not in use, a vehicle occupant may fully use an item storage space formed in a console without visually recognizing a cup holder device. When necessary, the cup holder may be deployed from the bottom portion of the item storage space in response to operation by the vehicle occupant, thereby providing improved convenience to the vehicle occupant.

Particularly, since the cup holder is deployed from a portion of the item storage space in the console, the remaining space of the item storage space may be still used as the item storage space, thereby enabling the cup holder to be deployed in a state in which an item is stored in the item storage space in the console.

Further, when the cup holder is deployed at night when the vehicle interior is dark, light is emitted only when the cup holder is appropriately deployed, thereby enabling the vehicle occupant to easily check whether the cup holder is appropriately deployed and to visually recognize the position of the cup holder. Additionally, the vehicle occupant may check whether a cup is stored in the cup holder through the color of emitted light. Accordingly, since the vehicle occupant may check whether the cup holder is appropriately deployed and may visually recognize the cup stored in the cup holder, the vehicle occupant may not attempt to put an additional cup on the cup stored in the cup holder, thereby preventing the beverage in the cup from being spilled out.

As is apparent from the above description, according to the embodiment of the present disclosure, since the cup holder is completely hidden when not in use, a vehicle occupant may fully use an item storage space formed in a console without visually recognizing the cup holder device. When necessary, the cup holder may be deployed from the bottom portion of the item storage space in response to operation by the vehicle occupant, thereby providing improved convenience to the vehicle occupant.

Particularly, since the cup holder is deployed from a portion of the item storage space in the console, the remaining portion of the item storage space may still be used as the item storage space, thereby enabling the cup holder to be deployed in a state in which an item is stored in the item storage space in the console.

Further, when the cup holder is deployed at night when the vehicle interior is dark, light is emitted only when the cup holder is appropriately deployed, thereby enabling the vehicle occupant to easily check whether the cup holder is appropriately deployed and to visually recognize the position of the cup holder. Additionally, the vehicle occupant may check whether a cup is stored in the cup holder through the color of emitted light. Accordingly, since the vehicle occupant may check whether the cup holder is appropriately deployed and may visually recognize the cup stored in the cup holder, the vehicle occupant may be dissuaded from putting an additional cup on the top of the stored cup, thereby preventing the beverage in the cup from spilling.

The effects of the present disclosure are not limited to the above-mentioned effects, and other effects not mentioned herein will be clearly understood by those skilled in the art to which the present disclosure pertains from the detailed description of the embodiments.

Although preferred embodiments of the present disclosure have been disclosed for illustrative purposes, those skilled in the art will appreciate that various modifications, additions, and substitutions are possible without departing from the scope and spirit of the disclosure. Therefore, the embodiments described in the present disclosure are not intended to limit the technical idea of the present disclosure, and the technical idea of the present disclosure is not limited by the embodiments. The protection scope of the present disclosure should be interpreted by the following claims, and all technical ideas within the scope equivalent thereto should be construed as being included in the scope of the present disclosure.

What is claimed is:

1. A hidden-type cup holder device comprising:
a housing disposed in a console and comprising an item storage space defined by a first space area and a second space area connected to each other, and further comprising a base unit mounting part provided at a lower portion of the first space area;
a support member fixedly mounted on the housing;
a base unit positioned on the base unit mounting part, wherein the base unit has an upper surface formed to be flush with a bottom surface of the second space area to form a bottom surface of the first space area, one end of the base unit is supported by the support member, and an opposite end of the base unit is rotated by a first predetermined angle to be erected in the item storage space; and
a cup holder unit mounted on the base unit, the cup holder unit being rotatably deployed at a second predetermined angle to provide a cup support space for storing a cup therein.

2. The hidden-type cup holder device as claimed in claim 1, further comprising a skin member comprising a first skin area fixedly in contact with the upper surface of the base unit, a second skin area fixedly in contact with the bottom surface of the second space area, and a connection area formed of a flexible material connecting the first skin area to the second skin area,
wherein entirety of an upper surface of the skin member is formed as a single surface and is continuously flat.

3. The hidden-type cup holder device as claimed in claim 1, wherein the housing has a step defined by a height difference between the bottom surface of the second space area and the base unit mounting part and further comprises a support member mounting hole formed in the step, and
wherein the support member comprises:
a support plate fixedly mounted on an underside of the bottom surface of the second space area; and
a base unit coupling part extending from the support plate and coupled to the base unit through the support member mounting hole to support rotation of the base unit.

4. The hidden-type cup holder device as claimed in claim 1, wherein the base unit comprises:
an upper plate having an upper surface forming the bottom surface of the first space area, the upper plate comprising a base rotation means mounting part provided at an inner surface of a rear end portion of the upper plate;
a lower plate coupled to a lower portion of the upper plate and configured for the cup holder unit to be mounted thereon, the lower plate comprising a support member coupling hole opening at a rear side surface of the lower plate, the support member coupling hole receiving a part of the support member; and
a base rotation means having one portion fixedly mounted on the base rotation means mounting part of the upper plate and the other portion rotatably mounted on the support member such that the base rotation means is rotated by first elastic force.

5. The hidden-type cup holder device as claimed in claim 4, wherein the base unit further comprises a base locking hole provided in a side surface thereof,
the hidden-type cup holder device further comprising a main switch unit mounted on the housing, the main switching unit comprising a base locking protrusion inserted into and coupled to the base locking hole in the base unit to restrict rotation of the base unit by the first elastic force of the base rotation means, the base locking protrusion being configured to be withdrawn from the base locking hole in the base unit in response to operation by a vehicle occupant.

6. The hidden-type cup holder device as claimed in claim 4, wherein the cup holder unit comprises:
a cup holder fixing member fixedly mounted on the lower plate of the base unit;
a cup holder body configured to provide the cup support space for storing the cup therein, the cup holder body comprising a cup holder rotation means mounting part provided on an inner surface of a rear portion of the cup holder body;
a cup holder lower case coupled to a lower portion of the cup holder body, the cup holder lower case comprising a cup holder fixing member coupling hole opening at a rear side surface of the cup holder lower case, the cup holder fixing member coupling hole receiving a part of the cup holder fixing member; and
a cup holder rotation means having one portion fixedly mounted on the cup holder rotation means mounting part of the cup holder body and the other portion rotatably mounted on the cup holder fixing member such that the cup holder body is rotatably deployed from the base unit by second elastic force.

7. The hidden-type cup holder device as claimed in claim 6, wherein the cup holder unit further comprises a cup support means, wherein one end of the cup support means is rotatably mounted on the cup holder lower case, and an opposite end of the cup support means contacts the cup stored in the cup support space, thereby elastically pushing the cup stored in the cup support space to maintain a position of the cup.

8. The hidden-type cup holder device as claimed in claim 6, wherein the cup holder lower case of the cup holder unit further comprises a cup holder locking hole provided in a lower surface of the cup holder lower case,
the hidden-type cup holder device further comprising a cup holder switch unit mounted on the base unit, the cup holder switch unit comprising a cup holder locking protrusion locked in and coupled to the cup holder locking hole in the cup holder unit to restrict rotational deployment of the cup holder body by the second elastic force of the cup holder rotation means, the cup holder locking protrusion being configured to be unlocked from the cup holder locking hole in the cup holder unit in response to operation by a vehicle occupant.

9. The hidden-type cup holder device as claimed in claim 6, further comprising a stopper means comprising:
a first stopper member; and
a second stopper member provided on the base unit so as to allow, when the base unit is rotated by the first predetermined angle to be erected in the item storage space, an end surface of the second stopper member to contact an end surface of the first stopper member,
wherein the first stopper member and the second stopper member contact each other to restrict rotation of the base unit such that the base unit is not rotated beyond the first predetermined angle of the base unit.

10. The hidden-type cup holder device as claimed in claim 6, further comprising a cup holder deployment light-emitting means comprising:
a light-emitting part provided on the cup holder unit and configured to emit light when power is applied thereto;
a power supply part configured to supply the power; and
an upper contact terminal comprising a first upper contact terminal provided on an outer surface of the cup holder body of the cup holder unit, the first upper contact terminal being electrically connected to the light-emitting part, and a second upper contact terminal provided on an inner surface of the lower plate of the base unit, the second upper contact terminal being electrically connected to the power supply part,
wherein, when the cup holder unit is rotatably deployed from the base unit within a predetermined range, the first upper contact terminal and the second upper contact terminal contact each other to cause the light-emitting part to emit light.

11. The hidden-type cup holder device as claimed in claim 10, wherein the cup holder unit further comprises a cup support means, wherein one end of the cup support means is rotatably mounted on the cup holder lower case, and an opposite end of the cup support means contacts the cup stored in the cup support space, thereby elastically pushing the cup stored in the cup support space to maintain a position of the cup,
wherein the cup holder deployment light-emitting means further comprises a cup detection part provided on the cup support means, the cup detection part being configured to detect contact between the cup support means and the cup stored in the cup support space, and
wherein the light-emitting part emits the light having different colors depending on a detection result by the cup detection part.

12. The hidden-type cup holder device as claimed in claim 9, further comprising a cup holder deployment light-emitting means comprising:
a light-emitting part provided on the cup holder unit and configured to emit light when power is applied thereto;
a power supply part configured to supply the power; and
a lower contact terminal comprising a lower first contact terminal provided on the end surface of the first stopper member, the lower first contact terminal being electrically connected to the power supply part, and a lower second contact terminal provided on the end surface of the second stopper member, the lower second contact terminal being electrically connected to the light-emitting part,
wherein, when the base unit is supported by the support member and is rotated to be erected within a predetermined range, the lower first contact terminal and the lower second contact terminal contact each other to cause the light-emitting part to emit the light.

13. A console system disposed in a vehicle interior, the console system comprising at least one hidden-type cup holder device as claimed in claim 1.
